(19) United States
(12) Patent Application Publication
(10) Pub. No.: US 2007/0057967 A1
(43) Pub. Date: Mar. 15, 2007

(54) System and method for the display of versioned documents and amendments

(76) Inventor: Orin Russell Armstrong, Becker, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/485,766

(22) Filed: Jul. 13, 2006

Related U.S. Application Data
(60) Provisional application No. 60/698,787, filed on Jul. 13, 2005.

(51) Int. Cl. G09G 5/00

(52) U.S. Cl. 345/619

(57) ABSTRACT

A system and method are disclosed for displaying on a computer display a periodically amended document, such as statutes, regulations, city ordinances, or other legal rules. The system enables a user to easily view the currently effective version of the document, prior versions of the document, future versions of the document containing amendments already passed by a legislative body, and the amending documents (or acts) that have altered or will alter the document, and the changes made by the amending documents. The displays of amendments and document text can be carried backward or forward to display multiple cycles of amendments and resulting text, resulting in a complete history of the document. Additionally, the invention informs the user of the precise dates upon which amendments took effect, or will take effect, along with the beginning and ending effective dates for each displayed version of the document.

### FIELD OF THE INVENTION

This invention relates to the computerized display of legal rules and other documents that are modified or amended from time to time.

### BACKGROUND OF THE INVENTION

Existing database systems such as the LexisNexis research system display statutes through a computer interface. These existing systems display the current version of a statute. In addition, these existing systems cite the legislative acts which have amended the statute. Existing systems also incorporate databases of the text of statutes in effect in previous years. However, it is difficult for users to determine the difference between the various versions of the text, because the effect of the various amendments is not set forth, only the result.

### SUMMARY OF THE INVENTION

The present invention overcomes the limitation of prior art systems in displaying the text of documents that are periodically amended, such as statutes, regulations, or city ordinances. The invention enables a user viewing the currently effective version of a statute to view the most recent amendments to that statute that resulted in the currently effective version, and to easily view the text of the statute prior to such amendments. Alternatively, the invention permits the user viewing the currently effective version of a statute to view amendments to that statute which will take effect in the future, and to view the text of the statute as it will appear after such amendments. The display of amendments and statute text can be carried backward or forward to display multiple cycles of amendments and resulting text, resulting in a complete history of the statute. Additionally, the invention informs the user of the precise beginning and ending dates for which a version of the text of the statute was, is, or will be effective. Additionally, the invention displays the effect of the expiration of earlier amendments upon the text of a statute.

### BRIEF DESCRIPTION OF THE DRAWINGS

FIG. 1 is a screen display showing the text of a current version of a first statute.

FIG. 2 is a screen display showing hyperlinks to the text of different versions of the statute of FIG. 1 and to the legislative acts which from time to time amended the text of the first statute.

FIG. 3 is a screen display showing amendments made by a particular legislative act to the text of the statute of FIG. 1.

FIG. 4 is a screen display showing the text of the statute of FIG. 1 prior to the amendments made by the legislative act as shown in FIG. 3.

FIG. 5 is a screen display showing additional information relating to a particular legislative act relating to the statute of FIG. 1.

FIG. 6 is a screen display showing the text of a current version of a second statute with a known future change.

FIG. 7 is a screen display showing hyperlinks to the text of different versions of the statute of FIG. 6 and to the legislative acts which from time to time amended, or will amend, the text of the second statute.

FIG. 8 is a screen display showing amendments made by a particular legislative act to the text of the statute of FIG. 6 in the future.

FIG. 9 is a screen display showing the text of the version of the statute of FIG. 6 that will be in effect after the amendments set forth in FIG. 8.

FIG. 10 is a screen display showing hyperlinks to the text of different versions of a third statute and to the legislative acts which from time to time amend the text of the third statute.

FIG. 11 is a screen display showing amendments made by a particular legislative act to the text of the statute of FIG. 10 in the future.

FIG. 12 is a flow chart of a method used by the present invention.

### DETAILED DESCRIPTION OF THE INVENTION

The present invention has identified various problems with existing database systems as they relate to statutes, regulations, ordinances, or other legal precepts (which are collectively referred to herein as legal rules). Legislatures, executive entities, city councils, or other bodies that issue legal rules are also authorized to amend legal rules they have issued, thereby causing the text of the legal rules to vary over time. Unfortunately, the existing database systems do not effectively display the time-varying nature of these legal rules to the users of these systems. In most cases, the existing systems do not display amendments to the legal rules separately from the text of the legal rules, but simply describe those changes. While they sometimes contain annualized collections of earlier versions of all the statutes in a particular database, they require the user to change databases and to re-access the particular statute. In addition, they generally show only the version of the statute in effect at the end of the annual period, and do not show versions of the text in effect for interim periods. Similarly, existing systems do not display the effects of the expiration of amendments upon the underlying text of the legal rules. Instead, users are forced to create the desired version manually by comparing an amendment to the current text of legal rule. Finally, the present invention has identified that the existing systems do not display the dates during which a particular version of a legal rule was in effect, or will be effective, nor do they display the effective dates of the amendments to the legal rules.

The present invention overcomes this system by providing an enhanced ability to display the time-varying nature of legal rules. This invention is accomplished in a computerized system in which a central processor unit displays legal rules on a user's terminal screen. The legal rules are stored in a computerized, persistent storage device such as one or more disk or tape drives. These legal rules may be stored as data in a database, where the database is able to manipulate the data in order to display the legal rules in a way desired by the user. Alternatively, the legal rules may be stored as separate documents or pages that can be displayed directly to users.

The legal rules in the present invention exist as multiple versions, with each version having a different effective date range. Amendments or changes are associated with the versions, with the amendments indicating how one version of the legal rule is to be amended to become the next version. It is possible that each of the versions and the amendment itself is stored separately on the persistent storage device. Alternatively, only the versions can be changed with the amendments being determined by calculating the differences between the versions. As a second alternative, it is possible to store only the first version and all of the amendments, with each successive version being calculated by applying the amendments to the earlier version.

The display of the legal rules is under the control of a standard computer program that can operate on a microprocessor, minicomputer, or mainframe computer. The user's terminal screen can be a computer screen on a microcomputer upon which the standard computer program is operating. Alternatively, the terminal screen may take the form of a browser that interfaces with the standard computer program operating on a remote computer through the World Wide Web. Other configurations of data storage, operation of the computer program, and connection between the user terminal and the computer program are well known in the prior art and are within the scope of the present invention.

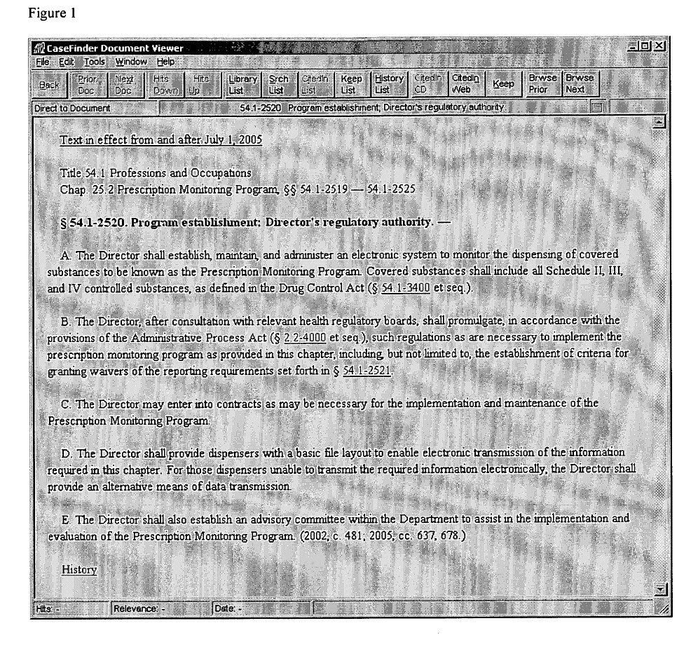

A first implementation of the invention, shown in FIGS. 1 through 5, effectively displays the current version of a legal rule as well as the amendments and text versions prior to the current version. The legal rule shown in this implementation is § 54.1-2520 of the Virginia Code. This section is shown as it might appear in text-viewing software on a computer or terminal screen in FIG. 1. One element of the invention is revealed in the line at the top of the screen, which displays the period of time during which the displayed version of the text is in effect. As shown in FIG. 1, § 54.1-2520 became effective on Jul. 1, 2005, and will continue in effect until the Virginia legislature amends it or repeals it.

Beneath the top line in FIG. 1, information is provided to locate this particular section within the larger body of statues comprising the Virginia Code, in any of many means known in the art. In this example, the Title and Chapter in which § 54.1-2520 will be found are set out by means of their numerical codification and description.

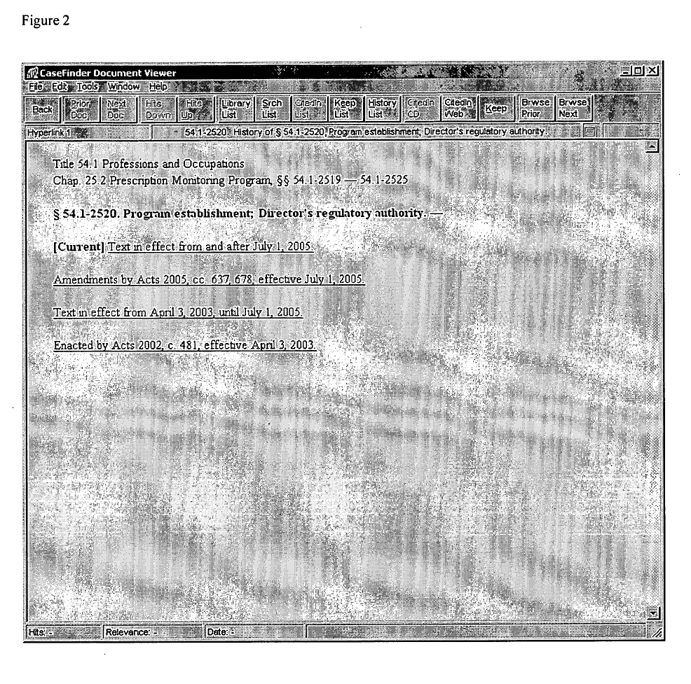

At the bottom of FIG. 1, the word “History” appears in the form of a hyperlink, familiar in the art. Any word can appear as a hyperlink; the word “History” has no special significance to the invention. Clicking on the link causes the display in FIG. 2 to appear on the computer screen.

In FIG. 2, it can be seen that the information identifying and locating the code section in FIG. 1 is repeated at the top of the screen. Beneath that, four hyperlinks appear.

The first hyperlink in FIG. 2 points to the document shown in FIG. 1. It is an element of the invention that this hyperlink is labeled “Current.” Clicking this link would simply take the user “back” to FIG. 1. In situations where a statute has been amended numerous times in the past and will also be amended in the future, the inclusion of the “Current” label is instructive to the user. Any word connoting the “current” status of the document being pointed to could be substituted.

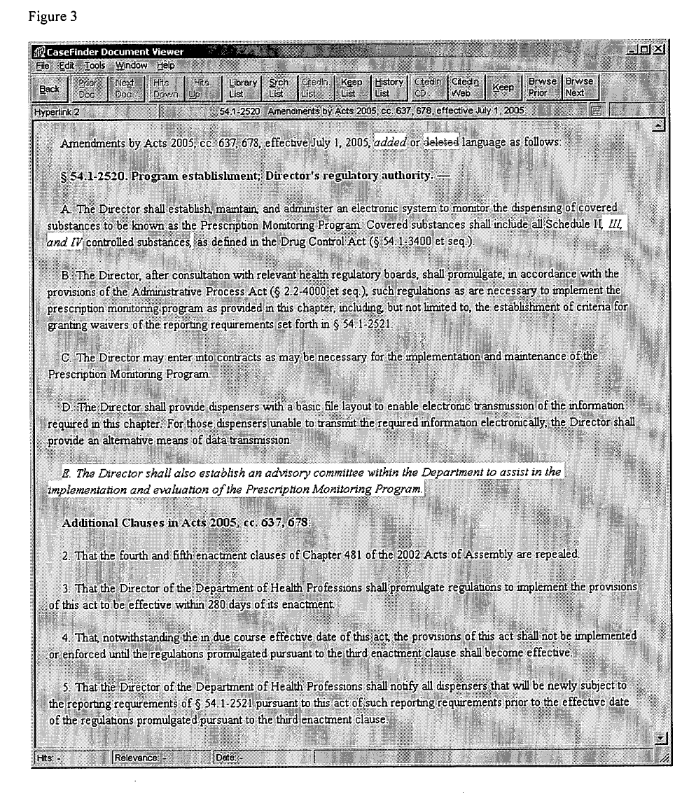

The second hyperlink in FIG. 2 points to amendments to this section that became effective on Jul. 1, 2005, and identifies the official enactments of the Virginia legislature which promulgated those amendments. Clicking this link takes the user to FIG. 3.

In FIG. 3, another element of the invention is shown at the top of the screen. The official act(s) of the Virginia legislature which promulgated these amendments (in this case, chapters 637 and 678 of the 2005 session) are identified, together with the date upon which those amendments became effective (in this case, Jul. 1, 2005). The amendments to the text of the statute are shown in distinctive text, in this case, italicized blue text for language that was added, and red strike-through text for language that was deleted. No claim is being made to the use of highlighting to delineate added and deleted text, which is well known in the art, but it is an element of the invention that the amendments are displayed separately and graphically, rather than simply being described in writing. Note additionally that the background color of each element of text added or deleted is set off from the rest of the background, making inconspicuous amendments, such as the addition of the comma after the word “substances” in paragraph A, easily recognized. Another element of the invention is displayed at the bottom of FIG. 3, in which additional information related to the official amendments is set forth. In this case, chapters 637 and 687 contained additional clauses that may bear upon the effect of the amendments, and the text of those clauses is set out.

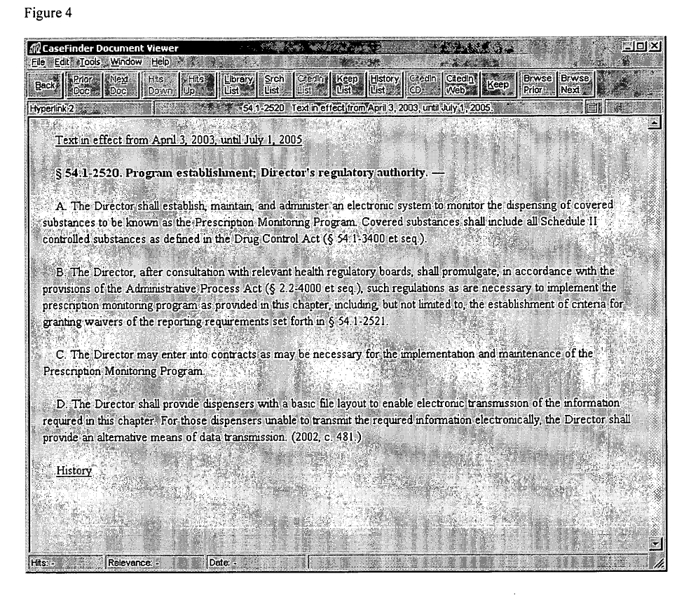

From FIG. 3, clicking the document viewer's “back” button returns the user to FIG. 2. The third hyperlink in FIG. 2 points to the version of the text that was in effect from Apr. 3, 2003, until Jul. 1, 2005, that is, prior to the amendments displayed in FIG. 3. Clicking this link takes the user to FIG. 4.

In FIG. 4, a previously noted element of the invention is shown again in first line at the top of the document, which sets forth the period of time during which this version of the text was in effect. Note at the bottom of the document, the word “History” appears as a hyperlink, as it did in the current version of the statute as shown in FIG. 1. Clicking this link will take the user to FIG. 2. It is optional within the implementation of the invention whether or not to include cross-hyperlinks between and among the various amendments and versions of the text of the statutes.

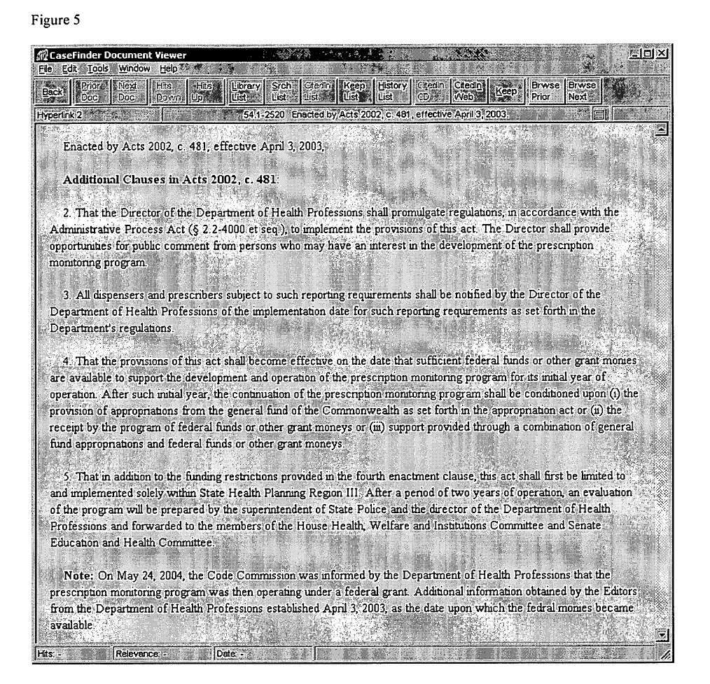

From FIG. 4, clicking on the “History” link, or using the document viewer's “back” button, returns the user to FIG. 2. The fourth and last hyperlink in FIG. 2 points to information regarding the original enactment of this section of the Virginia Code. Clicking this link takes the user to FIG. 5.

In FIG. 5 a previously noted element of the invention is shown again at the top of the screen. The official act of the Virginia legislature that promulgated this statute (in this case, chapter 481 of the 2003 session) is identified, together with the date upon which the statute first became effective (in this case, Apr. 3, 2003). Another previously-noted element of the invention is again displayed in FIG. 5, in which additional information related to the enactment is set forth. In this case, chapter 481 contained additional clauses which may bear upon the statute, and they are set forth. In addition, an editor's “Note” has been included at the bottom of the screen to provided additional clarifying information regarding the enactment. From FIG. 5, clicking the document viewer's “back” button returns the user to FIG. 2.

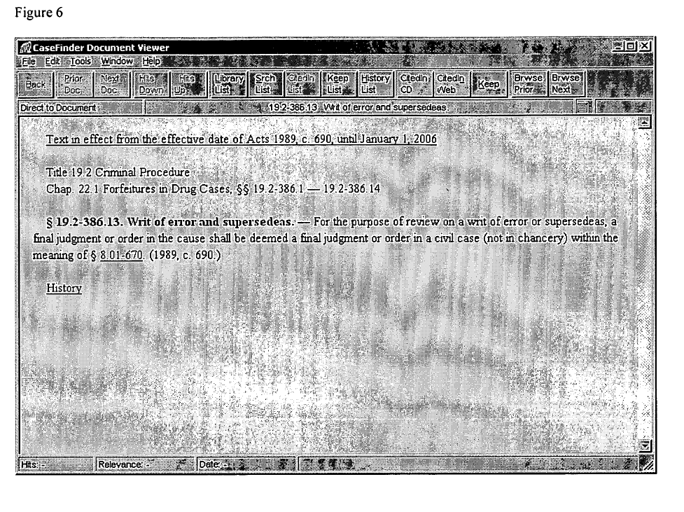

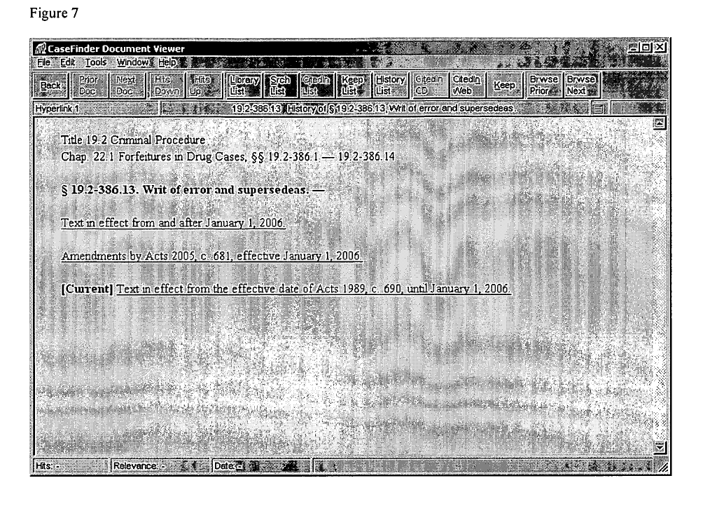

A second embodiment of the present invention is shown in FIGS. 6 through 9. This embodiment displays amendments and text versions of a legal rule that will take effect in the future. FIG. 6 shows the version of the text of § 19.2-386.13 of the Virginia Code as it might appear in text-viewing software on a computer screen on a date prior to Jan. 1, 2006. A previously noted element of the invention is revealed in the line at the top of the screen, which displays the period of time during which this version of the text of statute is in effect. As shown in FIG. 6, this version of § 19.2-386.13 became effective on the effective date of Chapter 690 of the 1989 Acts of the Virginia legislature, and will remain in effect until a future date (shown as Jan. 1, 2006 in FIG. 6). The user is thereby alerted that this version of the text will no longer be in effect after that date. As previously described, clicking on the hyperlink at the bottom of the screen (in this instance, the link might have said “Future Amendments” instead of “History”) takes the user to FIG. 7.

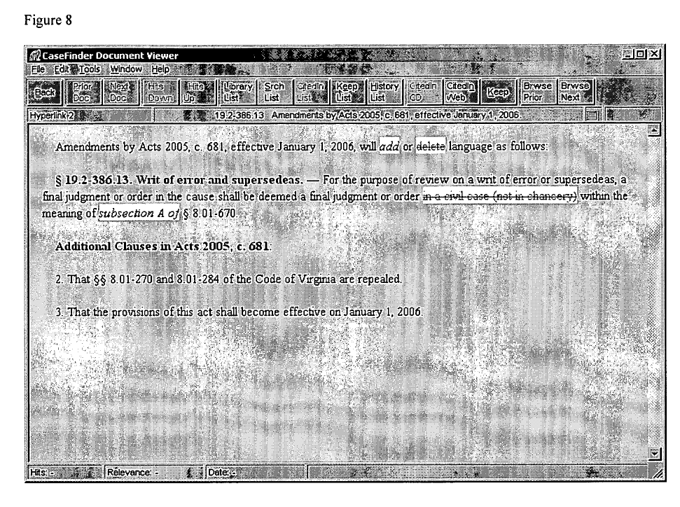

FIG. 7 is similar to FIG. 2, discussed above. However, in this instance, the “current” version of the text of the statute appears as the third and last hyperlink. Above it, the second hyperlink points to amendments to this section that will become effective on Jan. 1, 2006, identifying the official enactments of the Virginia legislature that promulgated those amendments. Clicking this link takes the user to FIG. 8.

In FIG. 8, a previously noted element of the invention is again shown at the top of the screen. The official act of the Virginia legislature that promulgated these amendments (chapter 681 of the 2005 session) is identified, together with the date upon which the amendments will become effective (Jan. 1, 2006). A previously-noted element of the invention is that the amendments to the text of the statute are shown in distinctive text, in this case, italicized blue text for language that was added, and red strike-through text for language that was deleted. Note additionally that the background color of each element of text added or deleted is set of from the rest of the background. Another previously-noted element of the invention is displayed at the bottom of FIG. 8, in which additional information related to the amendments is set forth.

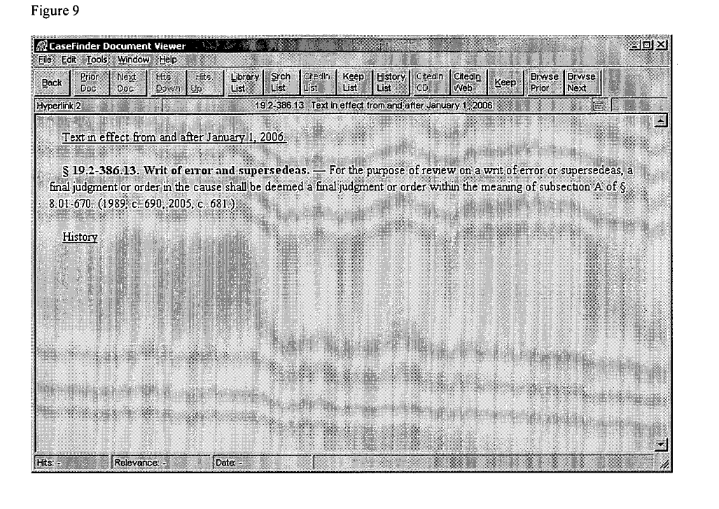

From FIG. 8, clicking the document viewer's “back” button returns the user to FIG. 7. In FIG. 7, the first (top) hyperlink points to the version of the text that will be in effect from and after Jan. 1, 2006, that is, after the amendments displayed in FIG. 8 become effective. Clicking this link takes the user to FIG. 9.

In FIG. 9, a previously noted element of the invention is shown again in the first line at the top of the document, which sets forth the period of time during which this version of the text will be in effect. As shown in FIG. 9, this version of § 19.2-386.13 will become effective on a future date (shown as Jan. 1, 2006 in FIG. 9), and will continue in effect thereafter until the Virginia Legislature amends it or repeals it.

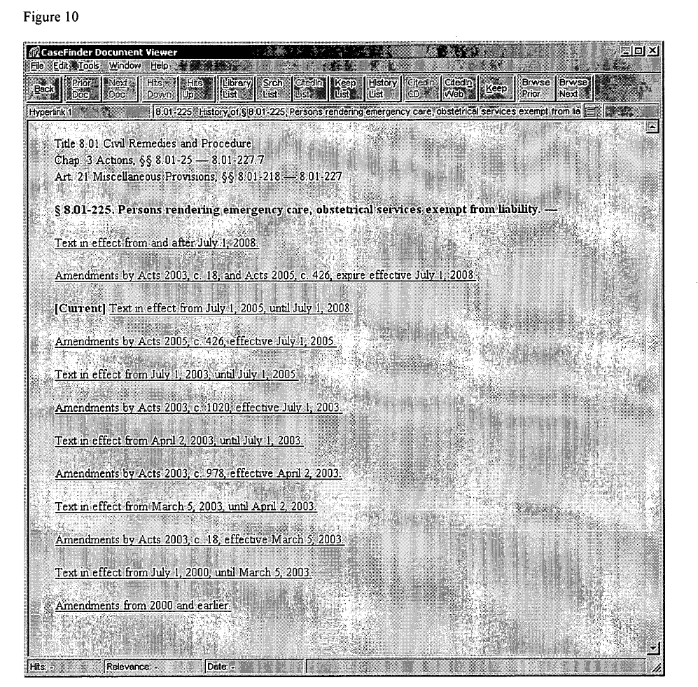

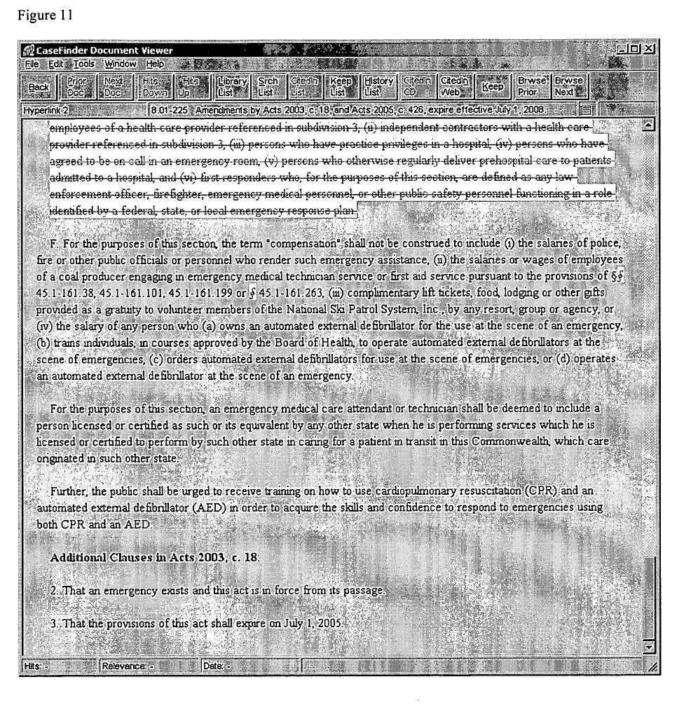

A third embodiment of the present invention is shown in FIGS. 10 and 11. In this embodiment, the invention displays amendments and text versions which have been implemented in the past and which will take effect in the future.

FIG. 10 shows the “history” file for a section of the Virginia Code that has been amended numerous times in the past, some of which will expire in the future. Thus, the link to the “current” version of the text of the statute is the third hyperlink on the page. The second hyperlink in FIG. 10 points to the amendments that will expire on Jul. 1, 2008. Clicking this link takes the user to FIG. 11.

FIG. 11 displays the last several paragraphs of a long document which incorporates an element of the invention; changes to this statute that will occur with the expiration of earlier amendments are displayed using highlighted text to reveal which words are added and which words are deleted.

As is familiar from the previous descriptions, the top hyperlink in FIG. 10 will take the user to the version of the text that will be in effect after the expiration of amendments as shown in FIG. 11 takes effect.

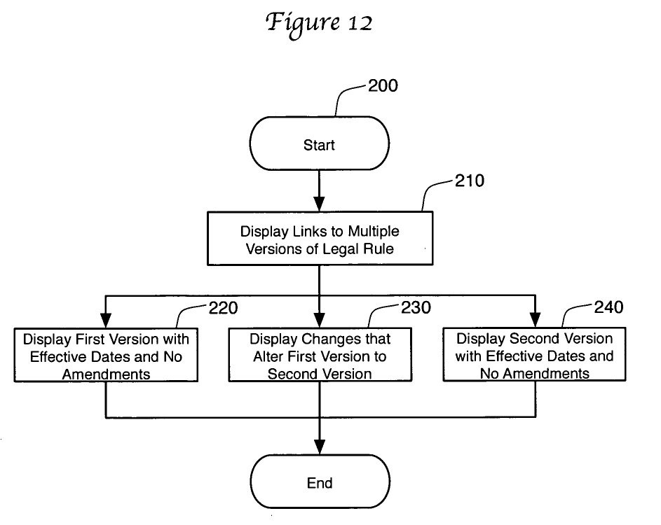

FIG. 12 shows a method 200 used by the present invention. In this method 200, a first display is presented to the user in step 210 that presents links to different versions of a particular legal rule. If the first link is selected, a first version of the legal rule is shown to the user in step 220. This version is effective for a particular date range, which may include the current date. The effective data range is displayed along with the first version of the legal rule.

If a second link is selected from step 210, the amendments or changes that are made to the first version of the legal rule to create a second version are displayed to the user in step 230. Typically, a legislature, an administrative body, a city council, or some other controlling body will create this amendment in order to update the legal rule to reflect the current philosophy of the controlling body. For instance, a legislature may pass an Act to amend a statute in order to update the statute as it desires. The amendments embodied in this Act are displayed to the user in step 230 in order for the user to see how the legal rule has been changed by the amendment. In addition to displaying the amendment, step 230 may also display information included in the Act other than the statutory amendment. This is shown in the bottom portion of FIGS. 3, 5, 8, and 11.

When the third link is selected in step 210, the second version of the legal rule is displayed in step 240. This second version shows the end result of applying the amendment shown in step 230 to the first version of the legal rule shown in step 220.

The links shown in step 210 may be found on a single display screen that is presented to the user. These links may appear with no actual text from any version of the legal rule, such as the links shown in FIGS. 2, 7, and 10. Alternatively, these links may appear on the same display screens as the one of the versions of, or the amendments to, the legal rule. In one embodiment, the links appear at the top or bottom of every page or display that relates to the legal rule.

The many features and advantages of the invention are apparent from the above description. Numerous modifications and variations will readily occur to those skilled in the art. For instance, although the invention is described in terms applicable to legal research systems, this is not meant to limit the fields to which the invention will apply. Consequently, in addition to legal rules, the present invention may be applied to any documents that are amended over time and have known effective dates. Since such modifications are possible, the invention is not to be limited to the exact construction and operation illustrated and described. Rather, the present invention should be limited only by the following claims.

What is claimed is:

1. A computerized method for displaying a document that changes over time, where each change results in a different version of the document and where each version has known effective dates, the method comprising:
a) displaying on a computerized screen a plurality of links relating to the document including a first link, a second link, and a third link;
b) upon the selection of the first link, displaying on the screen a first version of the document including effective dates for the first version;
c) upon the selection of the second link, displaying on the screen changes to the first version of the document that alters the first version of the document into a second version of the document; and
d) upon the selection of the third link, displaying on the screen the second version of the document including effective dates for the second version.

2. The computerized method of claim 1, wherein the document is a legal rule.

3. The computerized method of claim 2, wherein the legal rule is selected from a group consisting of a statute, a regulation, and an ordinance.

4. The computerized method of claim 1, wherein the steps of displaying of the first version, the changes, and the second version each include displaying a hyperlink that, upon selection, causes the display of the plurality of links on the computer screen.

5. The computerized method of claim 1, wherein the steps of displaying of the first version, the changes, and the second version each include displaying the plurality of links on the computer screen.

6. The computerized method of claim 1, wherein the step of displaying the changes to the first version further includes displaying additional information related to the changes.

7. The computerized method of claim 1, wherein the effective dates for the second version indicate that the second version takes effect in the future.

8. A computerized system for displaying versions of a legal rule on a browser comprising:
a) data stored on a computer storage device, the data relating to a first version of the legal rule and data allowing the determination of a second version and the amendment made to the first version to create the second version; and
b) computerized software for displaying on the browser the following pages:
i) a first page showing the first version of the legal rule;
ii) a second page showing the amendment made to the first version to create the second version; and
iii) a third page showing the second version of the legal rule.

9. The system of claim 8, wherein the computerized software further displays hyperlinks to the first, second, and third pages on a separate fourth page.

10. The system of claim 8, wherein each of the first, second, and third pages contain hyperlinks to the other two pages.
